(19) United States
(12) Patent Application Publication
(10) Pub. No.: US 2013/0247272 A1
(43) Pub. Date: Sep. 26, 2013

(54) PROVIDING IMAGES ON FUNCTIONAL OBJECTS

(71) Applicants: Jason T. Reed, Longville, LA (US); Kimberly Anne Moreno, Lake Charles, LA (US); Chadwick Abel Moreno, Lake Charles, LA (US); Joshua Ryan McGee, Lake Charles, LA (US); Walter S. Nolen, Lake Charles, LA (US)

(72) Inventors: Jason T. Reed, Longville, LA (US); Kimberly Anne Moreno, Lake Charles, LA (US); Chadwick Abel Moreno, Lake Charles, LA (US); Joshua Ryan McGee, Lake Charles, LA (US); Walter S. Nolen, Lake Charles, LA (US)

(21) Appl. No.: 13/829,059

(22) Filed: Mar. 14, 2013

Related U.S. Application Data
(60) Provisional application No. 61/614,254, filed on Mar. 22, 2012.

(51) Int. Cl. G06K 15/02

(52) U.S. Cl. CPC G06K 15/021
USPC 2/161.1; 358/1.18; 112/475.09

(57) ABSTRACT

A method of producing a graphic on a substrate includes receiving an image, determining a print pattern corresponding to the image, and replicating the print pattern as a graphic on a substantially flat, flexible and contiguous substrate. The print pattern is bounded by a cut pattern that represents multiple layflat components of a functional, three dimensional object. Determining the print pattern includes mapping selected portions of the image onto selected portions of the cut pattern, and altering the mapped portions of the image based on at least one of an expected three dimensional topography associated with a component and an expected seam area associated with the component.

### CROSS-REFERENCE TO RELATED APPLICATIONS

This application claims the benefit and priority of U.S. Provisional Application Ser. No. 61/614,254, filed Mar. 22, 2012, the entire contents of which is hereby incorporated by reference.

### TECHNICAL FIELD

The present disclosure relates to providing images, such as graphics, on functional objects and specifically on a non-planar outer surface of a multi-component, three-dimensional object such as a baseball glove.

### BACKGROUND

Marking conventional consumer products (e.g., shirts, bags, shoes, etc.) with graphic designs is a well-established practice for providers of apparel and athletic gear. In many cases, the product is either completely or partially assembled prior to printing of the graphic design on its outer surface. This type of post-assembly printing is often accomplished using a prefabricated printing pattern. In some other cases, the products are printed or marked prior to assembly by printing graphics on small areas that are intended to remain substantially flat and/or seamless once the product is assembled.

### SUMMARY

In one aspect, a method of producing a graphic on a substrate includes receiving an image, determining a print pattern corresponding to the image, and replicating the print pattern as a graphic on a substantially flat, flexible and contiguous substrate. The print pattern is bounded by a cut pattern that represents multiple layflat components of a three dimensional object. Further, in some examples, determining the print pattern includes mapping selected portions of the image onto selected portions of the cut pattern, and altering the mapped portions of the image based on at least one of an expected three dimensional topography associated with a component and an expected seam area associated with the component.

In some cases, receiving an image includes receiving a customized digital image file.

In some applications, replicating the print pattern on a substrate includes replicating the image on a natural leather hide.

In some embodiments, replicating the print pattern on a substrate includes applying a layer of ink to a surface of the substrate. The ink may include a water-based pigment ink.

In some instances, mapping selected portions of the image onto selected portions of the cut pattern includes mapping curtailed projections of the image onto the cut pattern.

In some applications, mapping selected portions of the image onto selected portions of the cut pattern includes mapping overlapping projections of the image onto the cut pattern.

In some cases, altering the mapped portions of the image includes at least one of warping, compressing, or stretching the mapped portions.

In another aspect, an object with a non-planar outer surface carrying an image includes at least two pieces of flexible, sheet-form material secured together along a seam so as to form the non-planar outer surface, each piece of flexible material carrying a respective portion of the image and having an edge region defined between the seam and a hidden edge of the piece adjacent the seam. The respective portion of the image carried by each piece is formed by a graphic printed on the piece, the graphic printed on each piece extending beyond the seam into the edge region, such that at least a portion of the graphic is hidden in the seam.

In some examples, the sheet-form material includes untreated leather hide.

In some cases, the seam includes an overlapping seam.

In some embodiments, the seam includes a plain seam.

In some applications, the graphic includes a layer of ink. The ink may include a water-based pigment ink.

In some instances, the pieces of material include components of a baseball glove.

In some applications, the pieces of material include components of an inflatable ball.

In some examples, one the pieces of material is significantly more flexible than another of the pieces of material.

In some cases, the graphic includes a projection of a selected portion of a digital image.

In some embodiments, the image appears substantially continuous when viewed from an approximately perpendicular angle from the pieces of flexible material.

In yet another aspect, a method of producing a multi-component object includes cutting through a substantially flat, flexible and contiguous substrate based on a predefined cut pattern to form at least two separate components; marking each component with a respective graphic based on a predefined print pattern, and coupling the two components at a seam such that at least one portion of the respective graphic on each component is hidden in the seam and at least one other portion of the respective graphic on each component is visible, the visible portions of the respective graphics forming a substantially continuous image extending across the seam. In some examples, the print pattern includes an altered mapping of a selected portion of a digital image.

In some examples, the cutting of the substrate occurs before the components are marked with a respective graphic.

In some cases, cutting through the substrate based on the cut pattern includes cutting along an edge defined by the cut pattern.

In some applications, coupling the two components includes sewing the components together at the seam.

In some embodiments, coupling the two components includes aligning the components based on alignment notches defined by the cut pattern.

In some instances, the print pattern includes one or more overlapping projections of the selected portion of the digital image.

In some examples, the method further includes bending at least one of the two components along an axis to provide a concave or convex outer surface.

In yet another aspect, a fielding baseball glove carrying an image includes a hand-shaped glove component including a flexible, sheet-form piece of material including a main body and multiple finger sections extending integrally from the main body, the hand-shaped glove component being arranged so as to define a curved outer surface, and at least one other glove component secured to the hand-shaped glove component by a seam. In some examples, the image is included of respective graphics marked on each of the glove components such that the image extends substantially continuously across each of the finger sections and the seam.

In yet another aspect, a method of producing a multi-component object includes: cutting through a substantially flat, flexible and contiguous substrate based on a predefined cut pattern to form at least two separate components; fixing the two components in a predefined orientation relative to one another; marking each component with a respective graphic based on a predefined print pattern, while the two components are held fixed; and coupling the two components at a seam such that at least one portion of the respective graphic on each component is hidden in the seam and at least one other portion of the respective graphic on each component is visible, the visible portions of the respective graphics forming a substantially continuous image extending across the seam.

In some examples, cutting through the substrate based on the cut pattern includes cutting along an edge defined by the cut pattern.

In some cases, coupling the two components includes sewing the components together at the seam.

In some applications, fixing the two components in a predefined orientation includes loading the components into a jig.

In some embodiments, the method further includes bending at least one of the two components along an axis to provide a concave or convex outer surface.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a front view of an example baseball glove marked with a graphic design.

FIG. 1B is a rear view of the baseball glove of FIG. 1A.

FIG. 2 is a diagram illustrating the projection of a two-dimensional image onto a cut pattern.

FIG. 3A is a top view of two adjacent layflat components of the baseball glove of FIG. 1A marked with curtailed projections of a two-dimensional image.

FIG. 3B is a cross-sectional view of a seam area between the components of FIG. 3A, when the baseball glove is assembled.

FIG. 3C is an enlarged front view of the seam area of FIG. 3B.

FIG. 4A is a top view of two adjacent layflat components of the baseball glove of FIG. 1A marked with extended projections of a two-dimensional image.

FIG. 4B is a cross-sectional view of a seam area between the components of FIG. 4A, when the baseball glove is assembled.

FIG. 4C is an enlarged front view of the seam area of FIG. 4B.

FIG. 5A is a top view of a layflat component of the baseball glove of FIG. 1A marked with a distorted projection of a two-dimensional image.

FIG. 5B is a top view of the component of FIG. 5A, when the baseball glove is assembled.

FIG. 6A is a perspective view of an example inflatable ball marked with a graphic design.

FIG. 6B is a side view of the inflatable ball of FIG. 6A.

FIG. 7 is a flow diagram illustrating a method of producing a graphic on a substrate.

FIG. 8A is a flow diagram illustrating a method of producing a multi-component object.

FIG. 8B is a diagram illustrating a technique for cutting and marking the components of a multi-component object with a graphic.

### DETAILED DESCRIPTION

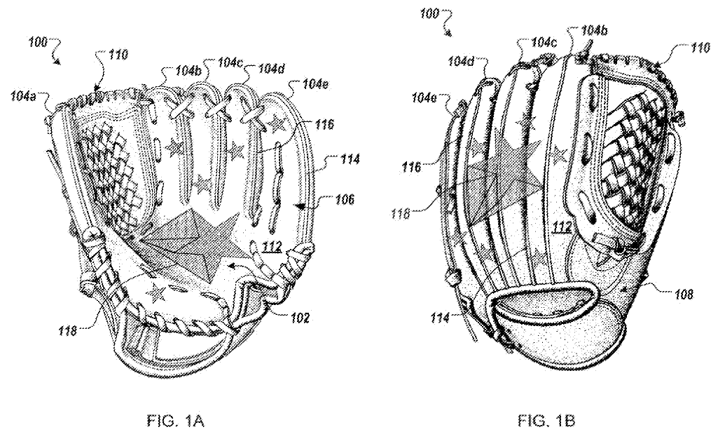

Referring first to FIGS. 1A and 1B, an example baseball glove 100 is shown in a fully assembled state displaying a customized graphic design. By “baseball glove” we refer to any type of hand-wear (e.g., gloves, mitts, etc.) suitable for use by fielders in playing baseball, softball, and other similar games. In this example, glove 100 provides a cup-shaped palm portion 102 that provides a pocket for catching a baseball, and five fingers 104a-e that extend from the palm. The fingers correspond to those of a human hand, including a thumb (104a), index finger (104b), middle finger (104c), ring finger (104d), and little finger (104e). However, the exact configuration of the glove (e.g., the size and shape of the palm and fingers, the number of fingers, etc.) may vary between different glove models, without departing from the scope of the present disclosure.

Glove 100 includes a ventral (front) shell 106, a dorsal (back) shell 108, and a web member 110 bridging the gap between the thumb and index glove fingers 104a, 104b. As shown, in the fully assembled state, the ventral shell is held in a concave shape, and the opposing dorsal shell is held in a convex shape. Accordingly, the ventral and dorsal shells together with the web member provide a non-planar outer surface 112 of the glove. In this example, ventral shell 106 includes a single, contiguous piece of material, while dorsal shell 108 is a multi-component structure. However, other suitable configurations can also be used (e.g., either or both of the ventral and dorsal shells can be multi-component structures or contiguous components). The material used for the shells and web member can include any suitable type of natural or synthetic sheet-form material (e.g., natural or synthetic leather, etc.) that is sufficiently flexible to be formed into a curved shape. In a particular example, an untreated leather hide (which may be tanned, but absent of any unnatural chemical substances, such as those used for preservation and/or fragrance) was used to fashion the ventral and dorsal shells, as well as the web member. As a matter of practicality, some components of the glove may be fashioned from either stiffer or more flexible pieces of material. For example, the palm section of the glove on the ventral shell, which may be configured to readily expand and contract to facilitate catching of a baseball, can be made from a more flexible piece of material than any of the dorsal shell components.

The individual multi-component structure(s) (i.e., either or both of the ventral and dorsal shells) can be formed by arranging discrete pieces of the sheet-form material in a manner that causes the edge of a first piece to overlap the edge of a neighboring second piece, such that the edge of the second piece is hidden from view, and attaching the pieces at linear points in the area of overlap to form an overlapping seam (e.g., by lacing, stitching, or appropriate forms of bonding flexible substrate material). Such a structure can also be formed by arranging pieces of the material in a manner that causes an edge of both pieces to be folded inward. The folded portions can be bonded to one another to form a plain seam that hides an edge of both glove components. By “seam”, we refer to any length-wise continuous attachment joint between overlapping pieces of sheet-form material that causes at least a selvedge portion of one piece to be hidden from view. In this example, dorsal shell 108 includes several seams 114 that attach its multiple components to one another. Ventral and dorsal shells 106, 108 also include several folds 116 around the fingers that cause at least a peripheral portion of the material to be hidden from view.

Ventral shell 106 and dorsal shell 108 are attached to one another at various seams along their periphery such that an open ended cavity is formed between them. The cavity is configured (e.g., shaped, sized, and otherwise arranged) to receive the hand of a user. For example, the cavity may define multiple partitioned stalls for receiving the fingers of a user.

In accordance with the present disclosure, glove 100 carries a graphic design on its curved, non-planar outer surface 112. The graphic design includes an arrangement of individual images 118 that stretch across various seams 114 and folds 116 of glove 100. The images are displayed on the outer surface of the glove such that they appear to be substantially continuous. To achieve this effect, each component of the glove is printed, prior to assembly, with a unique graphic that accounts for expected seams, folds, and curves that occur when the glove is assembled. By “printing” we refer to any appropriate technique for marking a substrate with a graphic (e.g., inking, dying, etching, branding, etc.). In a particular example, the outer surface of the glove was printed with a water based pigment ink applied by an industrial printer. In some examples, printing includes one or more operations following application of an ink or dye. For example, applying heat to a water-based ink or dye to bind the substance to the target substrate can be part of the printing.

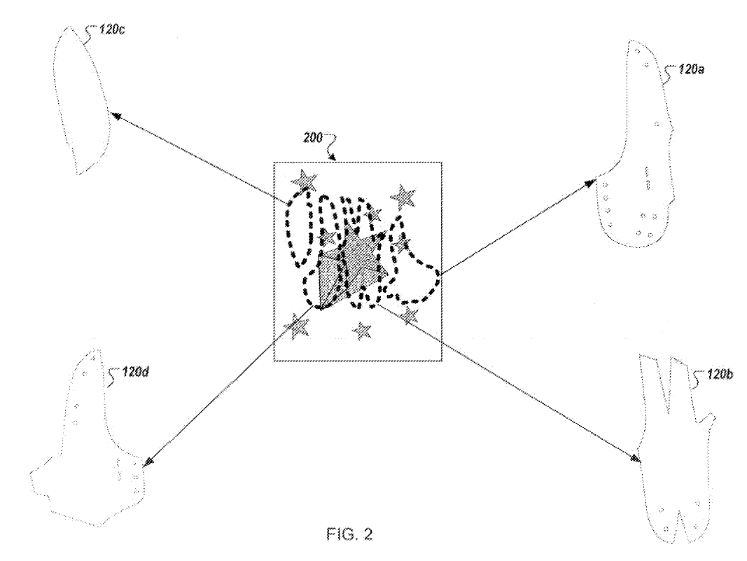

The graphic applied to each glove component may be projected from any suitable two-dimensional image. In some examples, the two-dimensional image is a customized image, which can be constructed using a suitable graphics design computer program. FIG. 2 illustrates an example of projecting a two-dimensional image 200 onto various glove components 120a-d prior to assembly. This assortment of glove components is defined by a predetermined cut pattern that designates the shape, size, and orientation of each piece. In some examples, the cut pattern is a digital, vector-based representation of the layflat glove components, which can be constructed using a suitable vector graphics editor computer program. The collection of image projections provided on the cut pattern forms the print pattern that is printed on the substrate. In some examples, the print pattern can be stored in computer memory and provided to a suitable industrial printer.

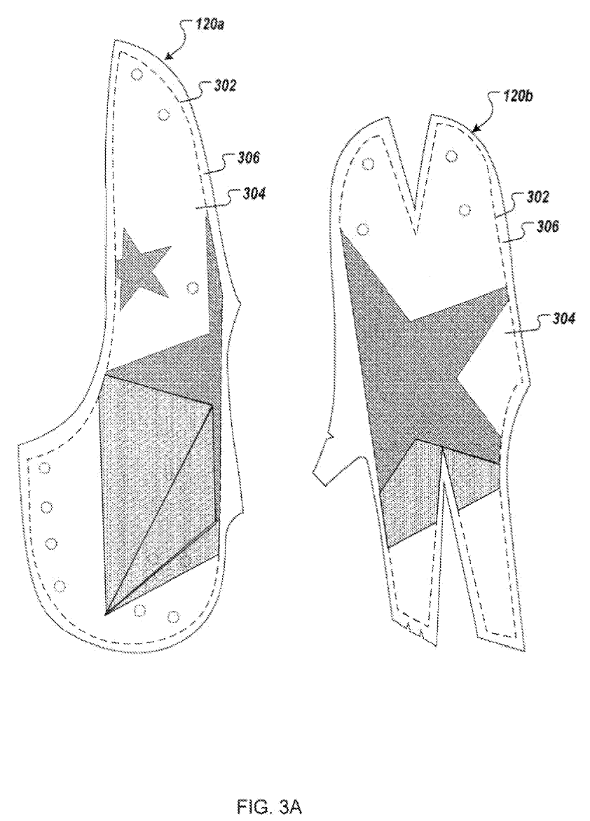

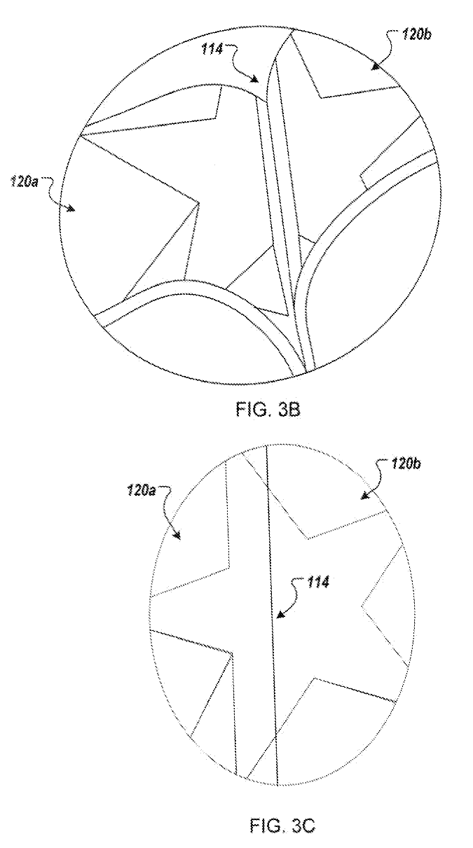

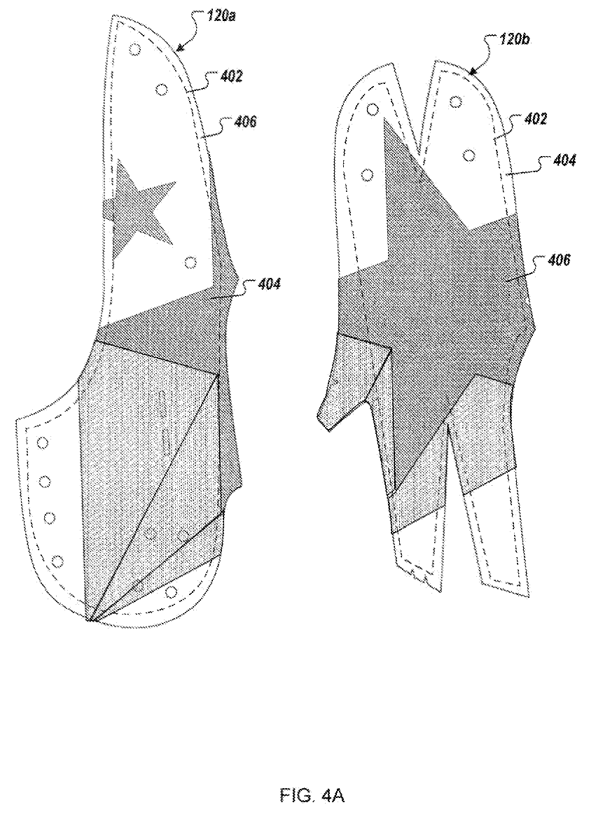

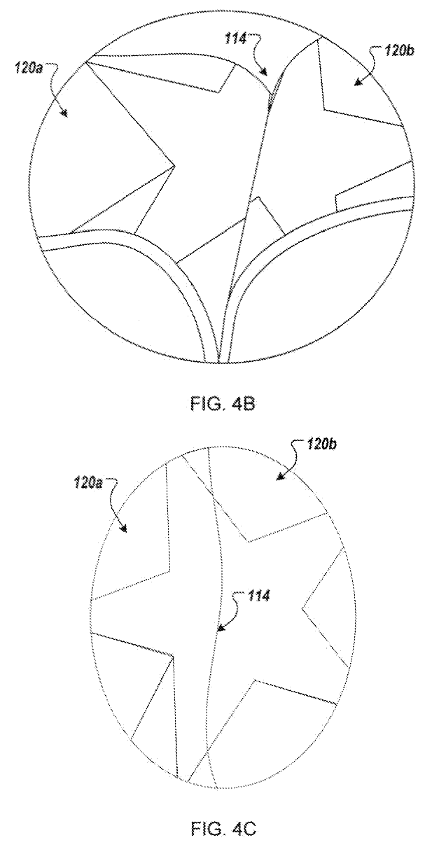

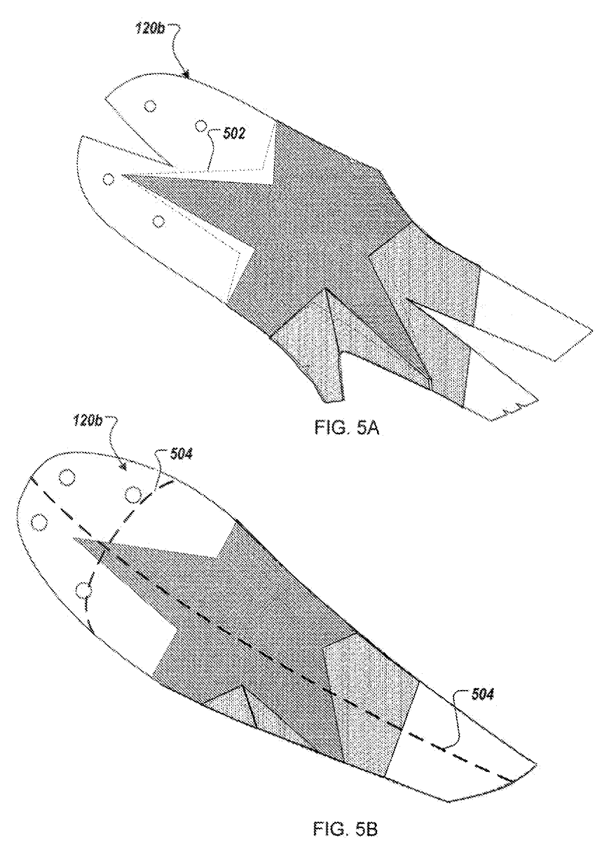

Components 120a-d are pieces of dorsal shell 106 that form the backside of the glove fingers. Of course, the glove may include several other components that are not shown in this exemplary illustration. The irregular shape of the glove components, as well as the expected curvature, seams, and folds of the glove in the assembled state, are accounted for in the image projection. In some examples, this is achieved by curtailing the projections such that any “hidden edges” introduced by the seams and/or folds between adjacent components are not marked with the graphic (see FIGS. 3A-3D). In some examples, adjacent glove components are provided with extended image projections that overlap one another to account for the hidden edges (see FIGS. 4A-4D). In other words, portions of the image are duplicated at the edges of those components that are to be seamed together, such that variation in seam placement that expose portions of the component selvedges expose some of the duplicated image portion but not unprinted selvedge surface. In some examples, the projection of the image onto one or more of the glove components is stretched, compressed, or otherwise distorted/altered to account for the expected curvature of a particular component when the glove is assembled (see FIGS. 5A and 5B), to provide a desired blended image as viewed from a distance.

Turning now to FIG. 3A, the cut pattern for adjacent glove components 120a and 120b is shown with an overlayed outline 302 separating the portion of the component 304 that is expected to be visible when the glove is in the assembled state from the expected hidden edges 306. As shown, in this example, the image projections are appropriately curtailed such that only the visible portion 304 of the components will be marked with the graphic. FIGS. 3B and 3C show how the projected graphics on the glove components form a substantially continuous image when the glove is assembled and viewed at a perpendicular distance from the glove surface. Further, as shown, the defined features of the image are generally aligned across the seam.

FIG. 4A provides an illustration of glove components 120a and 120b that is similar to FIG. 3A. Again, the glove components are overlayed with an outline 402 separating the portion of the component 404 that is expected to be visible in the assembled state from the expected hidden edges 406. In this example, however, the image projections extend over both the visible portion and the hidden edges of the glove components. As described above, the image projections even overlap one another such that each of the respective components is marked with a common portion of the original two-dimensional image. FIGS. 4C and 4D show how the projected graphics on the glove components form a substantially continuous image when the glove is assembled, even when there are variations in the seam.

The image projections mapped onto the cut pattern representations of the glove components can be standard stereographic projections of the image (e.g., one-to-one or two-to-one projections) that are left substantially unaltered. However, as described above, it may be advantageous in some cases to purposefully distort the image projections in order to account for curvature of the glove components that is expected to be introduced when the baseball glove is assembled. FIGS. 5A and 5B show glove component 120b in a layflat state and in an assembled state. As shown in FIG. 5A, the projection of the original, two-dimensional image has been intentionally distorted in the layflat state (line 502 indicates the original shape of the image projection). Distortion of the projected image can be achieved by implementing a conventional image projection technique (e.g., equirectangular, cylindrical, rectilinear, or fisheye image projections). Distortion can also be achieved by subsequent warping, stretching, or compressing a standard stereographic projection of the image. FIG. 5B shows how the distorted projection of the image appears flat or even on the curved surface of the component when the glove is assembled (the three dimensional topography of the component is indicated by profile lines 504). In other words, bending the components to assume their intended curvature in the finished assembly results in the projection of the desired, combined image when the object is viewed from a distance.

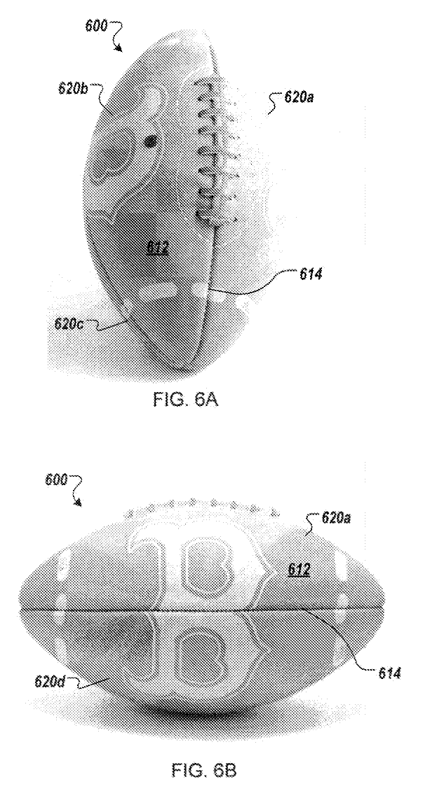

Although the above description and accompanying drawings portray implementations of a baseball glove, the techniques described herein can be used to provide the outer surface of many types of three-dimensional, multi-component objects with a graphic design that includes an arrangement of substantially continuous images spanning the irregular or curved surface of the object. FIGS. 6A and 6B, for example, show an example of an inflatable ball 600 (in this case, an American football) that includes an outer surface 612 carrying a substantially continuous image. In this example, the ball's outer surface is provided by a shell including four identical panels 620a-d of flexible, sheet-form material attached to one another by a respective seam 614. When inflated, each of the panels is forced into a convex orientation, providing a particularly non-planar outer surface.

Similar to the previous example, ball 600 carries a graphic design on its curved, non-planar outer surface 612. The graphic design includes an arrangement of individual images that span various seams 614 of ball 600. The images are displayed on the outer surface of the ball such that they appear to be substantially continuous across the seams, and relatively flat along the curved surface. To achieve this effect, each component of the glove is marked, prior to assembly, with a unique graphic that accounts for expected seams, curves, and possible stretching that may occur when the ball is assembled and inflated. The graphic applied to each glove component may be projected from a customized two-dimensional image.

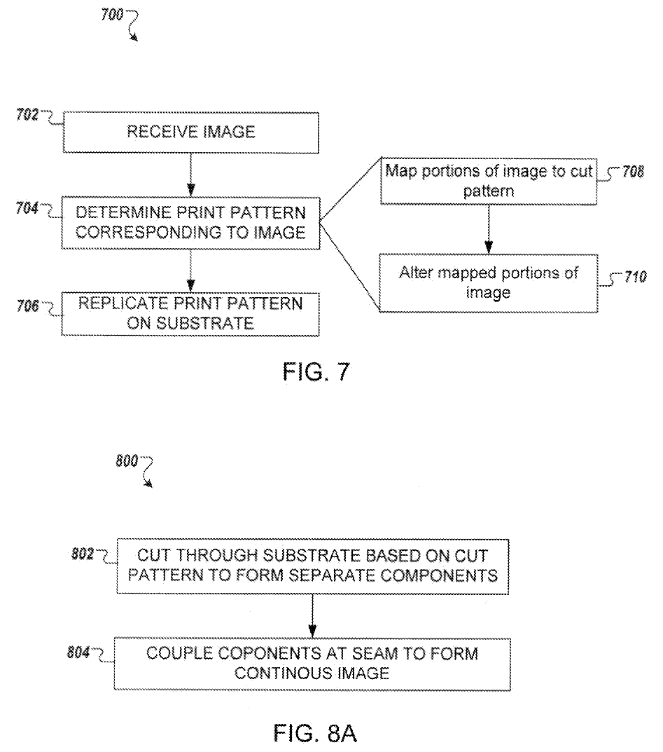

FIG. 7 is a flowchart of an example method 700 of producing a graphic on a substrate, such as for manufacturing a multi-component object carrying an image on a non-planar surface. According to method 700, an image is received (702). The image may be a two-dimensional image provided in either digital form or hard copy. A print pattern corresponding to the image is determined (704) and replicated on a substrate (706). The print pattern can be determined by mapping or projecting selected portions of the image onto selected portions of a cut pattern (708), and appropriately altering the projected portions of the image (710). As described above, the cut pattern marks the appropriate boundaries defining multiple layflat components of the object on the substantially flat, flexible, and contiguous substrate.

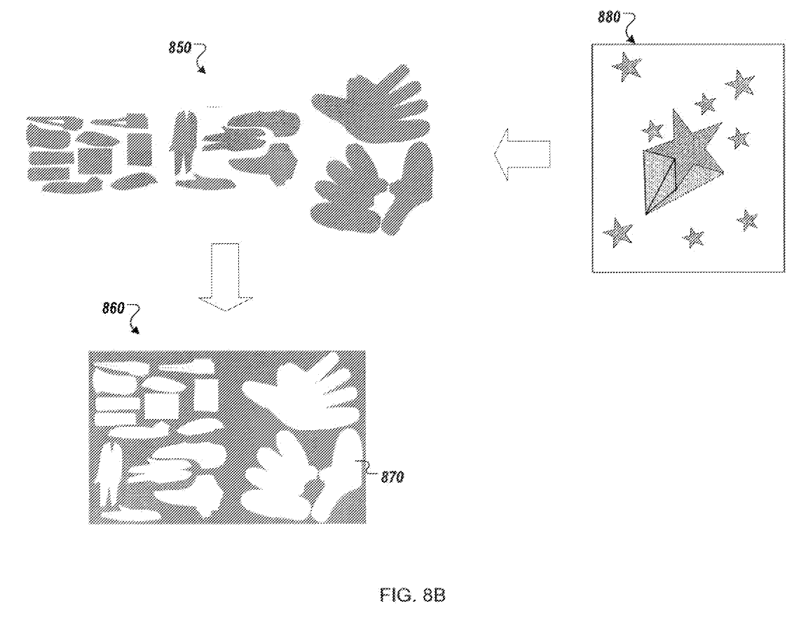

FIG. 8A is a flow chart of an example method 800 of producing a multi-component object, for example, from a substantially flat, flexible and contiguous substrate (e.g., contiguous leather hide). According to method 800, the substrate is cut (e.g., using a razorblade, scissors, or another appropriate type of cutter) based on a cut pattern to form separate components of the object (802). Each of the separate components may be marked with a respective graphic printed based on a print pattern that includes altered mappings or projections of an image. The separate components are coupled to one another (for example, by sewing) at a seam to form a substantially continuous image (804). For example, the components can be coupled such that at least a portion of the graphic on each component (or at least one of the components) is hidden, and at least a portion of the graphic on each component is visible. The visible portions of the graphics form the continuous image that extends across the seam. In some examples, the components are properly aligned before coupling at the seam. For instance, alignment notches defined by the cut pattern and/or the print pattern can be used to align the glove components properly before they are attached to one another.

FIG. 8B illustrates an example technique for implementing step 802 of method 800. In this example, the substrate is pre-cut, based on a cut pattern, to form the various individual components 850. Components 850 are then loaded into a jig 860 having openings 870 that match the shape and size of the various components. Altered mappings of a projected image 880 are then replicated onto the components while they are held by the jig 860 in a predefined orientation relative to one another. As noted above, the altered mappings may be organized in a print pattern.

In addition, as an alternative technique, the altered mappings can be replicated onto the contiguous substrate, according to the print pattern, before the cutting operation. In some implementations, pre-cutting the substrate as shown in FIG. 8B results in a more efficient use of the substrate material (e.g., better yield) and more precise replication (e.g., printing) of the altered image mappings. Further, the pre-cutting technique allows for individual pieces to be processed on demand, without wasting a large portion of the substrate material.

While a number of examples have been described for illustration purposes, the foregoing description is not intended to limit the scope of the invention, which is defined by the scope of the appended claims. There are and will be other examples and modifications within the scope of the following claims.

What is claimed is:

1. A method of producing a graphic on a substrate, the method comprising:
receiving an image;
determining a print pattern corresponding to the image, the print pattern being bounded by a cut pattern representing multiple layflat components of a three dimensional object; and
replicating the print pattern as a graphic on a substantially flat, flexible and contiguous substrate,
wherein determining the print pattern comprises:
mapping selected portions of the image onto selected portions of the cut pattern; and
altering the mapped portions of the image based on at least one of an expected three dimensional topography associated with a component and an expected seam area associated with the component.

2. The method of claim 1, wherein receiving an image comprises receiving a customized digital image file.

3. The method of claim 1, wherein replicating the print pattern on a substrate comprises replicating the image on a natural leather hide.

4. The method of claim 1, wherein replicating the print pattern on a substrate comprises applying a layer of ink to a surface of the substrate.

5. The method of claim 1, wherein mapping selected portions of the image onto selected portions of the cut pattern comprises mapping curtailed projections of the image onto the cut pattern.

6. The method of claim 1, wherein mapping selected portions of the image onto selected portions of the cut pattern comprises mapping overlapping projections of the image onto the cut pattern.

7. The method of claim 1, wherein altering the mapped portions of the image comprises at least one of warping, compressing, and stretching the mapped portions.

8. An object with a non-planar outer surface carrying an image, the object comprising:
at least two pieces of flexible, sheet-form material secured together along a seam so as to form the non-planar outer surface, each piece of flexible material carrying a respective portion of the image and having an edge region defined between the seam and a hidden edge of the piece adjacent the seam,
wherein the respective portion of the image carried by each piece is formed by a graphic printed on the piece, the graphic printed on each piece extending beyond the seam into the edge region, such that at least a portion of the graphic is hidden in the seam.

9. A method of producing a multi-component object, the method comprising:
cutting through a substantially flat, flexible and contiguous substrate based on a predefined cut pattern to form at least two separate components;
marking each component with a respective graphic based on a predefined print pattern; and
coupling the two components at a seam such that at least one portion of the respective graphic on each component is hidden in the seam and at least one other portion of the respective graphic on each component is visible, the visible portions of the respective graphics forming a substantially continuous image extending across the seam,
wherein the print pattern comprises an altered mapping of a selected portion of a digital image.

10. The method of claim 9, wherein cutting through the substrate based on the cut pattern comprises cutting along an edge defined by the cut pattern.

11. The method of claim 9, wherein coupling the two components comprises sewing the components together at the seam.

12. The method of claim 9, wherein the print pattern comprises one or more overlapping projections of the selected portion of the digital image.

13. The method of claim 9, further comprising bending at least one of the two components along an axis to provide a concave or convex outer surface.

14. The method of claim 9, wherein the cutting of the substrate occurs before the components are marked with a respective graphic.

15. A fielding baseball glove carrying an image, the baseball glove comprising:
a hand-shaped glove component comprising a flexible, sheet-form piece of material including a main body and multiple finger sections extending integrally from the main body, the hand-shaped glove component being arranged so as to define a curved outer surface; and
at least one other glove component secured to the hand-shaped glove component by a seam,
wherein the image is comprised of respective graphics marked on each of the glove components such that the image extends substantially continuously across each of the finger sections and the seam.

16. A method of producing a multi-component object, the method comprising:
cutting through a substantially flat, flexible and contiguous substrate based on a predefined cut pattern to form at least two separate components;
fixing the two components in a predefined orientation relative to one another;
marking each component with a respective graphic based on a predefined print pattern, while the two components are held fixed; and
coupling the two components at a seam such that at least one portion of the respective graphic on each component is hidden in the seam and at least one other portion of the respective graphic on each component is visible, the visible portions of the respective graphics forming a substantially continuous image extending across the seam.

17. The method of claim 16, wherein cutting through the substrate based on the cut pattern comprises cutting along an edge defined by the cut pattern.

18. The method of claim 16, wherein coupling the two components comprises sewing the components together at the seam.

19. The method of claim 16, fixing the two components in a predefined orientation comprises loading the components into a jig.

20. The method of claim 16, further comprising bending at least one of the two components along an axis to provide a concave or convex outer surface.
